(19) United States
(12) Patent Application Publication
(10) Pub. No.: US 2010/0287320 A1
(43) Pub. Date: Nov. 11, 2010

(54) Interprocessor Communication Architecture

(75) Inventors: Carlos Querol, Rochester, MN (US); James N. Snead, Eyota, MN (US); Michael S. Hicken, Rochester, MN (US); Randal S. Rysavy, Kasson, MN (US); Carl E. Forhan, Rochester, MN (US)

Correspondence Address: IP Legal Services, 1500 East Lancaster Avenue, Suite 200, P.O. Box 1027, Paoli, PA, 19301, US

(73) Assignee: LSI Corporation

(21) Appl. No.: 12/436,227

(22) Filed: May 6, 2009

(51) Int. Cl. G06F 9/46; G06F 13/24; G06F 15/76; G06F 9/06

(52) U.S. Cl. 710/260; 718/102; 712/30; 712/E09.003

(57) ABSTRACT

Described embodiments provide interprocessor communication between at least two processors of an integrated circuit, each processor running at least one task. For each processor, a proxy task is generated corresponding to each task running on each other processor. A task identifier for each task, and a look-up table having each task identifier associated with each other processor running the task is also generated. When a message is sent from a source task to a destination task that is running on a different processor than the source task, the source task communicates with the proxy task of the destination task. The proxy task appends the task identifier for the destination task to the message and sends the message to an interprocessor communication interface. Based on the task identifier, the processor running the destination task is determined and the destination task retrieves the message.

### CROSS-REFERENCE TO RELATED APPLICATIONS

The subject matter of this application is related to U.S. patent application Ser. No. ______ filed ______ 2009 as attorney docket no. ______, the teachings of which are incorporated herein by reference.

### BACKGROUND OF THE INVENTION

1. Field of the Invention

The present invention relates to interprocessor communications in a multiple processor system.

2. Description of the Related Art

Multiple processor systems are increasingly common in system-on-chip (SoC) designs where multiple processors might be present on the same die. In a multiple processor system, a group of processors execute a variety of tasks. Interprocessor communication (IPC) exchanges data between tasks when the tasks might be running across multiple processors. Messaging between two tasks may not always be the same, depending on whether the tasks are running on the same processor or on different processors. For example, each task might require information with respect to the location of each other task in order to properly exchange messages. Thus, the structure of IPC might be dependent on the architecture of the multiprocessor system.

For example, one method of IPC includes at least one communications bus between the multiple processors, such as a shared communications bus between all of the processors on the die. Another implementation might have dedicated communications buses between individual pairs of processors. The communications bus might be implemented with a Universal Asynchronous Receiver/Transmitter (UART), a Serial Peripheral Interface Bus (SPI) or other similar bus technology. Another exemplary method of IPC includes a shared memory between multiple processors. This shared memory approach might employ a shared address space that is accessible by all processors. A processor can communicate to another by writing information into the shared memory where the other processor can read it.

However, in the above approaches, each individual task might require information for the location of the other tasks in order to be able to properly communicate. For example, changing which processor runs which task, or changing the IPC hardware, might require changes to the software routine for each task.

### SUMMARY OF THE INVENTION

Described embodiments of the present invention provide interprocessor communication between at least two of a plurality of processors of an integrated circuit, where each processor is running at least one task. For each processor, a proxy task is generated corresponding to each task running on each other of the plurality of processors. A task identifier for each task, and a look-up table having each task identifier associated with each other processor running the task is also generated. When a message is sent from a source task to a destination task that is running on a different processor than the source task, the source task communicates with the proxy task of the destination task. The proxy task appends the task identifier for the destination task to the message and sends the message to an interprocessor communication interface. Based on the task identifier, the processor running the destination task is determined and the destination task retrieves the message.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a multiprocessor flash media system;

FIG. 2 shows a block diagram of an interprocessor communication system in accordance with an embodiment of the present invention;

FIG. 3 shows block diagram of an interprocessor communication system in accordance with another embodiment of the present invention; and

FIG. 4 shows a flow diagram of an interprocessor communication in accordance with another embodiment of the present invention.

### DETAILED DESCRIPTION

In accordance with embodiments of the present invention, interprocessor communication (IPC) is provided that is independent of system architecture in a multiprocessor environment. Thus, the location of individual tasks executed by each processor might be specified during a software compile-time, allowing for i) improved processor performance balancing, and ii) the addition of software tasks and features.

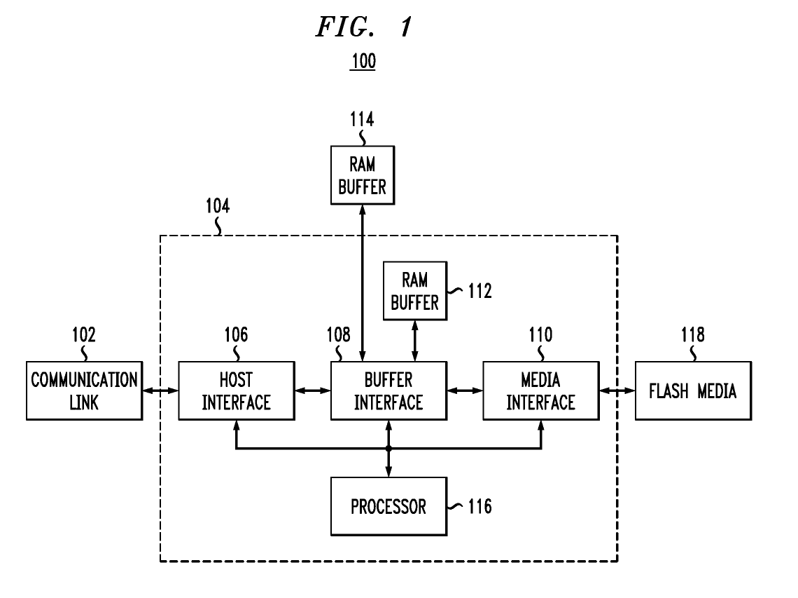

FIG. 1 shows a block diagram of exemplary flash memory storage system 100. As shown, flash memory storage system 100 is electrically coupled to communication link 102. Flash memory storage system 100 comprises flash controller 104 and flash media 118. Flash controller 104 might be implemented as a system-on-chip (SoC) design. Communication link 102 might be employed to communicate with external devices, such as a computer system, that interface with flash memory storage system 100. Communication link 102 might be a custom communication link, or might be a link operating in accordance with a standard communication protocol such as, for example, a Small Computer System Interface (“SCSI”) protocol bus, a Serial Attached SCSI (“SAS”) protocol bus, a Serial Advanced Technology Attachment (“SATA”) protocol bus, a Universal Serial Bus (“USB”), a Peripheral Component Interconnect (“PCI”) bus, an Ethernet link, an IEEE 802.11 link, or any other similar interface link for connecting a peripheral device to a computer.

Flash controller 104 controls the writing and reading of data between an external device connected to communication link 102 and flash media 118. Flash controller 104 comprises host interface 106, buffer interface 108, media interface 110, processor 116 and internal RAM buffer 112. Flash controller 104 might also be electrically coupled to, and in communication with additional external RAM, shown in FIG. 1 as RAM buffer 114. In an exemplary embodiment, internal RAM buffer 112 comprises 128 kB of static RAM (SRAM) and external RAM buffer 114 comprises 512 MB of double data rate version 2 dynamic RAM (DDR2 DRAM). Buffer 112 might act as a cache for processor 116, while buffer 114 might act as a read/write buffer between the flash media 118 and the external bus 102. Processor 116 comprises software/firmware as needed for operation. For example, host interface 106, buffer interface 108, and media interface 110 might be implemented as software functions running on processor 116. Alternatively, although shown in FIG. 1 as a single processor, processor 116 might be implemented by multiple processors.

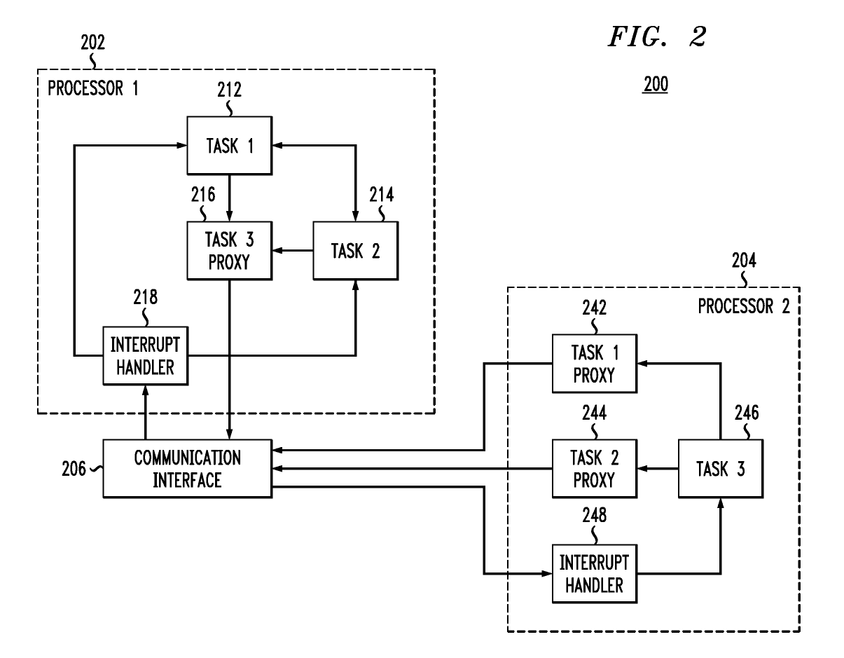

FIG. 2 shows a block diagram of interprocessor communication (IPC) architecture 200 in accordance with an exemplary embodiment of the present invention. As shown in FIG. 2, IPC architecture 200 comprises first processor 202, second processor 204 and communications interface 206. Communications interface 206 is coupled to both processor 202 and processor 204, and provides for communication between processor 202 and processor 204. Communications interface 206 might be, for example, a shared communications bus between processors 202 and 204. In embodiments of the present invention having more than two processors, there might be dedicated communications buses between individual pairs of processors. Communications interface 206 might be implemented as a Universal Asynchronous Receiver/Transmitter (UART), a Serial Peripheral Interface Bus (SPI), or shared memory between multiple processors having a shared address space that is accessible by all processors. Further, embodiments of the present invention might employ a combination of communication interface types, for example, employing one type for signaling and another type for data exchange. In such an embodiment, a processor bus and related hardware might be employed to send message pointers and shared memory might be employed to hold message data.

Each task running on a processor is assigned a unique identifier, termed herein as a “task identifier.” At software compile-time, the number of processors in the system is preferably set and the processor location of each task is determined. In one embodiment of the present invention, the determination is made based on criteria to achieve balanced processor performance. For example, a resource intensive task might be run on a separate processor, while multiple non-resource intensive tasks might be run together on one processor. When the software is compiled, a look-up table might be generated with each task identifier and the corresponding processor location for each task. The look-up table is accessible by communication interface 206. A proxy task is added for each task not running on a given processor. In some embodiments of the present invention, the look-up table might not be a separate entity, but rather might be implemented by the proxy task(s). In the case when processor 116 of FIG. 1 is implemented as a single processor, the proxy tasks might be eliminated. As shown in the figures herein, tasks are shown as modules, and such modules might be implemented purely in software, dedicated hardware, or in some combination of software and hardware.

As shown in FIG. 2, processor 1 202 runs tasks Task 1 212 and Task 2 214 and proxy task Task 3 Proxy 216. As described above, when a task is running on another processor, it is replaced by a proxy task. As indicated in FIG. 2, Task 1 212 is adapted to transmit information to Task 2 214 and Task 3 Proxy 216. Task 2 214 is adapted to transmit information to Task 1 212 and Task 3 Proxy 216. Task 3 Proxy 216 is adapted to transmit information to communication interface 206. Interrupt handler 218 is adapted to i) receive information from communication interface 206 and ii) transmit information to tasks Task 1 212 and Task 2 214. Consequently, in some embodiments, tasks Task 1 212 and Task 2 214 might be adapted to receive information from communication interface 206.

Processor 2 204 runs task Task 3 246, along with proxy tasks Task 1 Proxy 242 and Task 2 Proxy 244. As indicated in FIG. 2, Task 3 246 transmits information to Task 1 Proxy 242 and Task 2 Proxy 244. Task 1 Proxy 242 and Task 2 Proxy 244 are adapted to transmit information to communication interface 206. Interrupt handler 248 receives information from communication interface 206 and transmits information to Task 3 246. In one embodiment, Task 3 246 might be adapted to receive information from communication interface 206.

Tasks send messages from a source task to a destination task via a standard operating system (OS) message queue. When the source task and the destination task are both located on the same processor, the message is sent between the tasks via the OS queue. In an exemplary embodiment of the present invention, the OS queue is implemented by a buffer or register internal to each processor. Each task might have its own OS message queue. Proxy tasks send messages via an interprocessor communication (IPC) queue. In an exemplary embodiment of the present invention, the IPC queue is implemented by communication interface 206, which includes a first-in, first-out (FIFO) buffer. The FIFO buffer might be a shared memory that is accessible by some or all of the processors in the multiprocessor system.

When the source task and the destination task are not located on the same processor, the source task sends the message to the proxy task for the destination task via the OS queue. The proxy task sends the message to the destination task processor via the IPC queue. In some embodiments of the present invention, when a message is present in the IPC queue, an interrupt is generated to the destination task (shown in FIG. 2). In alternative embodiments, tasks periodically poll the communications interface for the presence of a message rather than an interrupt being generated when a message is present (not shown).

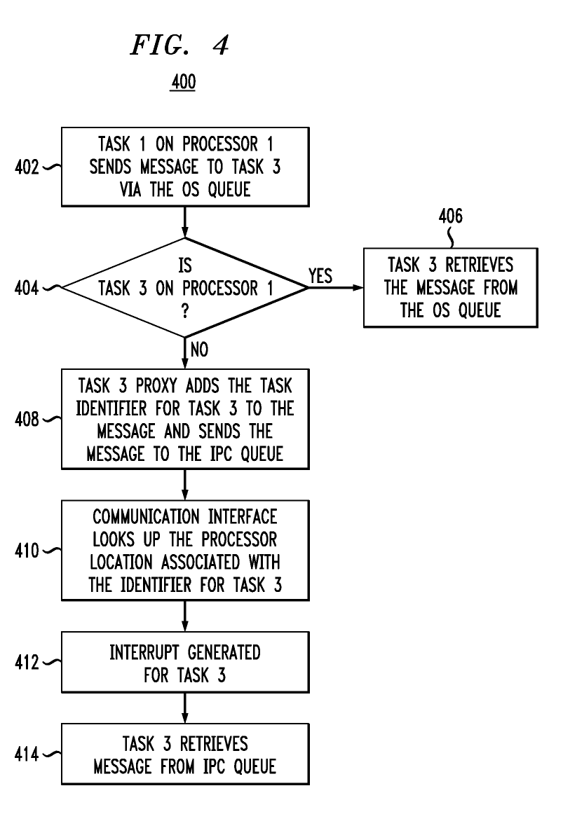

Referring now to both FIGS. 2 and 4, FIG. 4 shows an exemplary flow diagram of a message processes. As shown in FIG. 4, at step 402, Task 1 212 desires to send a message to another task. If the destination task is on the same processor as the source task (for example when the message is sent from Task 1 212 to Task 2 214), the message is sent to the destination task via the OS queue at step 406. Thus, no interprocessor communication is necessarily required because Task 1 212 is able to place a message directly into the OS queue for Task 2 214. In some embodiments of the present invention, the message data includes a pointer to a memory location such that the destination task might retrieve additional data. In alternative embodiments of the present invention, the message data might include substantially all of the data to be transferred between the tasks.

If the destination task is not on the same processor as the source task (for example, when the message is sent from Task 1 212 to Task 3 246), then interprocessor communication is employed. In this instance, at step 408, Task 1 212 sends its message to Task 3 Proxy 216 in the same manner as the task would transmit the message to Task 2 214, by placing a message in the OS queue for Task 3 Proxy 216. In this way, Task 1 212 transparently sends messages to any other destination task, whether the destination task is on the same processor or not. At step 408, Task 3 Proxy 216 also appends the task identifier for the destination task to the message and sends the message to the IPC queue. Thus, Task 3 Proxy 216 sends the task identifier and the message to communication interface 206. In other embodiments of the present invention, the destination task identifier might be sent out-of-band or via a separate communication channel.

As previously described, when software is compiled, a look-up table is generated with each task identifier and the corresponding processor location for each task. At step 410, communication interface 206 accesses the look-up table to determine the processor location of the destination task. Communication interface 206 might then route the message to the appropriate processor. In the present described exemplary embodiment, the look-up table shows that the message should be sent to processor 2 204. At step 412, communication interface 206 removes the task identifier from the message and interrupt handler 248 generates an interrupt for Task 3 246. In alternative embodiments (not shown in the figures), Task 3 246 might periodically poll communication interface 206 for the presence of a message.

In some embodiments of the present invention, communication interface 206 might also comprise shared memory accessible to some or all processors in the multiprocessor system. When communication interface 206 includes shared memory, the message data might be a pointer to a location in shared memory such that the destination task can access the memory location to retrieve additional data. Thus, an interrupt from interrupt handler 248 comprises a pointer to a location shared memory such that Task 3 246 might access the message in the shared memory. At step 414, Task 3 246 retrieves data from communication interface 206, for example, by reading the data from the location in shared memory indicated by the message. In alternative embodiments of the present invention, communication interface 206 does not include shared memory, and the message data comprises substantially all of the data to be transferred between the tasks. Response messages from Task 3 246 to Task 1 212 are sent in an analogous manner as that described above.

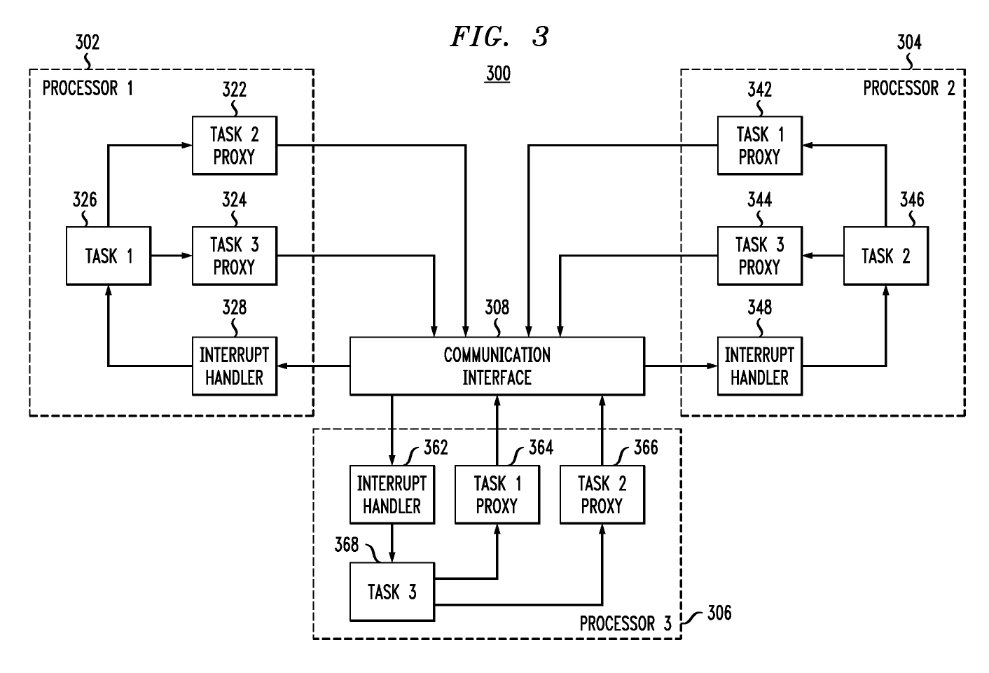

Referring to FIG. 3, a block diagram is shown of IPC architecture 300 in accordance with another exemplary embodiment of the present invention. As shown in FIG. 3, IPC architecture 300 comprises first processor 302, second processor 304, third processor 306 and communication interface 308. Communication interface 308 is coupled to processor 302, processor 304 and processor 306, and communication interface 308 allows for communication between the processors. As shown in FIG. 3, communication interface 308 is shared between all the processors. For embodiments where communication interface 308 comprises a single FIFO buffer, access to the FIFO buffer I/O lines might be multiplexed such that all the processors might share the single FIFO buffer. In alternative embodiments without a single FIFO buffer, each individual processor pair has a dedicated communication interface (not shown in the figures).

As shown in FIG. 3, Task 1 326, Task 2 Proxy 322 and Task 3 Proxy 324 are run on Processor 1 302. As described above, when a task is running on another processor, the task is replaced by a proxy task. As indicated in FIG. 3, Task 1 326 transmits information to Task 2 Proxy 322 and Task 3 Proxy 324. Task 2 Proxy 322 and Task 3 Proxy 324 transmit information to communication interface 308. Interrupt handler 328 i) receives information from communication interface 308 and ii) transmits information to Task 3 326. In one embodiment, Task 1 326 receives information from communication interface 308.

Task 2 346 runs on Processor 2 304, along with Task 1 Proxy 342 and Task 3 Proxy 344. As indicated in FIG. 3, Task 2 346 transmits information to Task 1 Proxy 342 and Task 3 Proxy 344. Task 1 Proxy 342 and Task 3 Proxy 344 transmit information to communication interface 308. Interrupt handler 348 receives information from communication interface 308 and transmits information to Task 2 346. In one embodiment, Task 2 346 receives information from communication interface 308.

Task 3 368 runs on Processor 3 306, along with Task 1 Proxy 364 and Task 2 Proxy 366. As indicated in FIG. 3, Task 3 368 transmits information to Task 1 Proxy 364 and Task 2 Proxy 366. Task 1 Proxy 364 and Task 2 Proxy 366 transmit information to communication interface 308. Interrupt handler 362 receives information from communication interface 308 and transmits information to Task 3 368. In one embodiment, Task 3 368 might receive information from communication interface 308.

As would be understood by one of skill in the art, the three processor embodiment of FIG. 3 operates in a manner analogous to that described previously with respect to the two processor embodiment described with regard to FIGS. 2 and 4. For example, as shown in FIG. 4, at step 402, Task 1 326 desires to send a message to another task. If the destination task is running on the same processor as the source task (for example, when the message is sent from Task 1 212 to Task 2 214, as shown in FIG. 2), the message is sent to the destination task via the OS queue at step 406. Thus, no interprocessor communication is necessarily required because Task 1 212 might place a message directly in the OS queue for Task 2 214. In some embodiments of the present invention, the message data is a pointer to a memory location such that the destination task might retrieve additional data. In alternative embodiments of the present invention, the message data comprises substantially all of the data to be transferred between the tasks.

If the destination task is not running on the same processor as the source task (for example, when the message is sent from Task 1 326 to Task 3 368), interprocessor communication is generally required. In this instance, at step 408, Task 1 326 sends its message to Task 3 Proxy 324 in the same manner as would be employed when sending a message to Task 2 346, by placing a message in the OS queue for Task 3 Proxy 324. In this manner, Task 1 326 transparently sends messages to any task, whether the destination task is on the same processor or not. At step 408, Task 3 Proxy 324 also appends the task identifier for the destination task to the message and sends the message to the IPC queue. Thus, Task 3 Proxy 324 sends the task identifier and the message to communication interface 308. As described above, when software is compiled, a look-up table is generated with each task identifier and the corresponding processor location for each task. At step 410, communication interface 308 accesses the look-up table to determine the processor location of the destination task. Thus, communication interface 308 might route the message to the appropriate processor. In the present example, the look-up table might show that the message should be sent to processor 3 306. At step 412, communication interface 308 removes the task identifier from the message, and interrupt handler 362 generates an interrupt for Task 3 368. In alternative embodiments (not shown in the figures), Task 3 368 might periodically poll communication interface 308 for the presence of a message.

In some embodiments of the present invention, communication interface 308 might also comprise shared memory accessible to some or all processors in the multiprocessor system. When communication interface 308 includes shared memory, the message data might be a pointer to a location in shared memory such that the destination task might access the memory location to retrieve additional data. Thus, an interrupt from interrupt handler 362 comprises a pointer to a location shared memory such that Task 3 368 might access the message in the shared memory. At step 414, Task 3 368 retrieves data from communication interface 308, for example, by reading the data from the location in shared memory indicated by the message. In alternative embodiments of the present invention, communication interface 308 does not include shared memory, and, for such embodiments, the message data comprises substantially all of the data to be transferred between the tasks. Response messages from Task 3 368 to Task 1 326 are generally sent in an analogous manner.

Although embodiments of the present invention have been described as comprising two or three processors, the present invention is not so limited. Similarly, although embodiments of the present invention have been described as comprising three tasks, the present invention is not so limited. It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processing blocks in a software program, including possible implementation as a digital signal processor, micro-controller, or general purpose computer, the present invention is not so limited. As would be apparent to one skilled in the art, various functions of software may also be implemented as processes of circuits. Such circuits may be employed in, for example, a single integrated circuit, a multi-chip module, a single card, or a multi-card circuit pack.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Signals and corresponding nodes or ports may be referred to by the same name and are interchangeable for purposes here.

We claim:

1. A method of interprocessor communication between at least two of a plurality of processors of an integrated circuit, each processor running at least one task, comprising:
a) generating, for each processor, i) a proxy task corresponding to each task running on each other of the plurality of processors, ii) a task identifier for each task, and iii) a look-up table having each task identifier associated with each other processor running the task;
b) sending a message from a destination task to a source task, wherein when the source task is running on a different processor than the destination task, the source task is communicating with the proxy task of the destination task;
c) appending, by the proxy task of the destination task, the task identifier for the destination task to the message;
d) sending the message from the proxy task of the destination task to an interprocessor communication interface;
e) determining, based on the task identifier, the processor running the destination task; and
f) retrieving, by the destination task, the message from the interprocessor communication interface.

2. The invention of claim 1, wherein after step e), the method further comprises:
generating an interrupt to the destination task to retrieve the message from the interprocessor communication interface.

3. The invention of claim 1, wherein the method further comprises:
polling, by each task, the interprocessor communication interface for a new message sent to the destination task.

4. The invention of claim 1, wherein, for steps d) and f), the interprocessor communication interface comprises a first-in, first-out (FIFO) buffer.

5. The invention of claim 1, wherein, for steps d) and f), the interprocessor communication interface comprises a shared memory.

6. The invention of claim 1, further comprising multiplexing and sharing the interprocessor communication interface by all of the plurality of processors.

7. The invention of claim 1, wherein step a) further comprises the step of compiling an installing software program code on each of the plurality of processors before the generating step.

8. The invention of claim 1, wherein each task identifier is unique.

9. The invention of claim 1, wherein at a task level, the proxy task appears identical to the task.

10. A machine-readable medium, having encoded thereon program code, wherein, when the program code is executed by a machine, the machine implements a method of interprocessor communication between at least two processors of a system having a plurality of processors, each processor running at least one task, comprising:
a) generating, for each processor, i) a proxy task corresponding to each task running on each other of the plurality of processors, ii) a task identifier for each task, and iii) a look-up table having each task identifier associated with each other processor running the task;
b) sending a message from a destination task to a source task, wherein when the source task is running on a different processor than the destination task, the source task is communicating with the proxy task of the destination task;
c) appending, by the proxy task of the destination task, the task identifier for the destination task to the message;
d) sending the message from the proxy task of the destination task to an interprocessor communication interface;
e) determining, based on the task identifier, the processor running the destination task; and
f) retrieving, by the destination task, the message from the interprocessor communication interface.

11. The invention of claim 10, wherein after step e), the method further comprises:
generating an interrupt to the destination task to retrieve the message from the interprocessor communication interface.

12. The invention of claim 10, wherein the method further comprises:
polling, by each task, the interprocessor communication interface for a new message sent to the destination task.

13. The invention of claim 10, wherein, for steps d) and f), the interprocessor communication interface comprises a first-in, first-out (FIFO) buffer.

14. The invention of claim 10, wherein, for steps d) and f), the interprocessor communication interface comprises a shared memory.

15. The invention of claim 10, further comprising multiplexing and sharing the interprocessor communication interface by all of the plurality of processors.

16. The invention of claim 10, wherein at a task level, the proxy task appears identical to the task.

17. An apparatus for interprocessor communication between at least two processors of a system having a plurality of processors, each processor running at least one task, comprising:
a) a generator for generating, for each processor, i) a proxy task corresponding to each task running on each other of the plurality of processors, ii) a task identifier for each task, and iii) a look-up table having each task identifier associated with each other processor running the task;
b) a first message queue for sending a message from a destination task to a source task, wherein when the source task is running on a separate processor than the destination task, the source task communicates with the proxy task of the destination task;
c) a second message queue for sending the message from the proxy task of the destination task to an interprocessor communication interface, wherein the proxy task appends to the message the task identifier for the destination task; and
e) a look-up table for determining, based on the task identifier, the processor running the destination task, wherein the destination task retrieves the message from the interprocessor communication interface.

18. The invention of claim 17, wherein the apparatus further comprises:
an interrupt handler for communicating to the destination task that there is a new message.

19. The invention of claim 17, wherein the interprocessor communication interface comprises a first-in, first-out (FIFO) buffer.

20. The invention of claim 17, wherein the interprocessor communication interface comprises a shared memory.
